(19) United States
(12) Patent Application Publication
(10) Pub. No.: US 2024/0295007 A1
(43) Pub. Date: Sep. 5, 2024

(54) METHOD FOR RECOVERING PROCESSED ALUMINUM SCRAPS OF AERONAUTICAL ALUMINUM ALLOY

(71) Applicant: The Boeing Company, Arlington, VA (US)

(72) Inventors: Zhi Wang, Beijing (CN); Guoyu Qian, Beijing (CN); Zhi Sun, Beijing (CN); Chunwei Liu, Beijing (CN); Hongbin Cao, Beijing (CN); Pengcheng Yan, Beijing (CN)

(73) Assignee: The Boeing Company, Arlington, VA (US)

(21) Appl. No.: 18/261,728

(22) PCT Filed: Mar. 4, 2022
(86) PCT No.: PCT/US2022/018830

§ 371 Date: Jul. 17, 2023

(30) Foreign Application Priority Data
May 14, 2021 (CN) 202110528009.X

(51) Int. Cl. C22B 21/00; B22D 21/00; C22B 1/02; C22B 1/16; C22B 7/00; C22C 1/02; C22C 1/03; C22C 21/14; C22C 21/16; C22C 21/18

(52) U.S. Cl. CPC C22B 21/0092; B22D 21/007; C22B 1/02; C22B 1/16; C22B 7/003; C22B 21/0007; C22C 1/026; C22C 1/03; C22C 21/14; C22C 21/16; C22C 21/18

(57) ABSTRACT

A method includes performing pre-treating, comprising fire-roasting or wet-washing, on the processed aluminum scraps of aeronautical aluminum alloy. The method further includes performing pressing formation on the pre-treated processed aluminum scraps of aeronautical aluminum alloy to form block-shaped aluminum scraps. The method further includes performing oxygen-controlled smelting on the block-shaped aluminum scraps in a smelting furnace to form aluminum alloy melt. The method further includes performing casting on the aluminum alloy melt to obtain an aluminum alloy product of meeting component requirements of aeronautical aluminum alloy.

### PRIORITY

This application claims priority from Chinese Pat. App. No. 202110528009.X filed on May 14, 2021.

### FIELD

The present disclosure relates to secondary resource recovery and, more particularly, to methods for recovering processed aluminum scraps of aeronautical aluminum alloy.

### BACKGROUND

Aluminum alloys, such as aeronautical aluminum alloy, are commonly used materials in the aircraft manufacturing industry, typically accounting for approximately 70% or more of the total weight of a fuselage. Recycling scrap material, such as chips produced during manufacturing processes, is desirous for reducing production costs, improving efficiency, and reducing waste. Drawbacks to current recycling processes arise due to surface oxidation, corrosion, cutting fluid and oil-water contamination on the scrapped material. Further, separating different grades of aluminum alloys is costly and laborious, thus a typical recovery rate of aeronautical aluminum scrap is low.

Accordingly, those skilled in the art continue with research and development efforts in the field of material recovery and, as such, apparatuses and methods intended to address the above-identified concerns.

### SUMMARY

The following is a non-exhaustive list of examples, which may or may not be claimed, of the subject matter according to the present disclosure.

Disclosed are methods for recovering processed aluminum scraps of aeronautical aluminum alloy.

In an example, the method includes performing pre-treating, comprising fire-roasting or wet-washing, on the processed aluminum scraps of aeronautical aluminum alloy. The method further includes performing pressing formation on the pre-treated processed aluminum scraps of aeronautical aluminum alloy to form block-shaped aluminum scraps. The method further includes performing oxygen-controlled smelting on the block-shaped aluminum scraps in a smelting furnace to form aluminum alloy melt. The method further includes performing casting on the aluminum alloy melt to obtain an aluminum alloy product of meeting component requirements of aeronautical aluminum alloy.

In another example, the method includes pre-treating the processed aluminum scraps of aeronautical aluminum alloy, the pre-treating including one or more of fire-roasting and wet-washing. The method further includes pressing the pre-treated processed aluminum scraps of aeronautical aluminum alloy to form block-shaped aluminum scraps. The method further includes oxygen-controlled smelting the block-shaped aluminum scraps in a smelting furnace to form aluminum alloy melt. The method further includes casting the aluminum alloy melt to obtain an aluminum alloy product.

Other examples of the disclosed systems, apparatuses, and methods will become apparent from the following detailed description, the accompanying drawings, and the appended claims.

### BRIEF DESCRIPTION OF THE DRAWINGS

FIG. 1 is an overall process flow diagram of a method for recovering processed aluminum scraps of aeronautical aluminum alloy according to an embodiment of the present disclosure;

FIGS. 2A-2F are photographs of an aluminum scrap melting process according to Example 1 of the present disclosure;

FIG. 3 is a photograph of a cast aluminum ingot according to Example 1 of the present disclosure;

FIG. 4 is a photograph of a cast aluminum ingot according to Example 2 of the present disclosure;

FIGS. 5A and 5B are photographs of a cast aluminum ingot according to Example 3 of the present disclosure;

FIG. 6 is a photograph of a cast aluminum ingot according to Example 4 of the present disclosure;

FIG. 7 is a photograph of a cast aluminum ingot according to Comparative example 1 of the present disclosure; and

FIG. 8 is an electron microscope photograph of a cast aluminum ingot inclusion according to Comparative example 2 of the present disclosure.

### DETAILED DESCRIPTION

Current recovery of processed aluminum scraps of aeronautical aluminum alloy faces challenges including cutting fluid and oil-water contamination of the aluminum scraps, easy oxidation, a low recovery rate, and a large amount of burning loss of aluminum during a melting process. After repeated and careful research, it is discovered that the above problems may be solved by integrated optimization of methods, such as fire-roasting or wet-washing is performed on the processed aluminum scraps of aeronautical aluminum alloy to remove cutting fluid and oil-water, then pressing formation is performed on the processed aluminum scraps, and an oxygen-controlled smelting process is used and the like, a purpose of efficiently recovering the processed aluminum scraps of aeronautical aluminum alloy is achieved. High efficiency in the present disclosure refers to two meanings, the first is to improve a melting rate of the aluminum scraps, and the second is to improve a recovery rate of the aluminum scraps. Based on these considerations and verification of a practice process, the present disclosure is provided.

Therefore, a main purpose of the present disclosure is to provide a method for recovering processed aluminum scraps of aeronautical aluminum alloy, to solve a problem in the prior art that the recovery efficiency of the processed aluminum scraps of aeronautical aluminum alloy is low.

In order to achieve the above purpose, according to the present disclosure, a method for recovering processed aluminum scraps of aeronautical aluminum alloy is provided, and the method comprises the following steps: performing pre-treating, comprising fire-roasting or wet-washing, on the processed aluminum scraps of aeronautical aluminum alloy; performing pressing formation on the pre-treated processed aluminum scraps of aeronautical aluminum alloy to form block-shaped aluminum scraps; performing oxygen-controlled smelting on the block-shaped aluminum scraps in a smelting furnace to form aluminum alloy melt; and performing casting on the aluminum alloy melt to obtain an aluminum alloy product of meeting component requirements of aeronautical aluminum alloy.

Further, the method further comprises performing oxygen-controlled refining on the aluminum alloy melt to achieve component optimization of the aluminum alloy melt after the oxygen-controlled smelting and before the casting.

Further, the processed aluminum scraps of aeronautical aluminum alloy are one or more of processed aluminum scraps of 2-series aluminum alloy and processed aluminum scraps of 7-series aluminum alloy.

Further, the fire-roasting is performed in air atmosphere, and a roasting temperature in the fire-roasting is 100-500° C.

Further, the wet-washing comprises washing and drying, washing liquid used in a washing process is one or more of industrial water, high purity water or ethyl alcohol, preferably the washing process is enhanced by using one or more of microwave vibration, ultrasonic vibration or mechanical stirring in the washing process, and preferably a drying temperature used in a drying process is 60-150° C.

Further, a density of the block-shaped aluminum scraps formed after the pressing formation is 1.0-5.0 t/m3.

Further, in the oxygen-controlled smelting, vacuum or inert gas protection is used to perform the control of oxygen potential, preferably oxygen partial pressure in the oxygen-controlled smelting is controlled to not more than 0.001 Pa.

Further, the oxygen-controlled smelting comprises achieving rapid melting of the blocked-shaped aluminum scraps in an oxygen-controlled condition, preferably the melting of the blocked-shaped aluminum scraps is accelerated with the help of electromagnetic stirring or gas blowing stirring in the oxygen-controlled smelting, preferably smelting time is 10-30 min, and a smelting temperature is 800-1100° C. in the oxygen-controlled smelting.

Further the vacuum or inert gas protection is used to perform the control of oxygen potential in the oxygen-controlled refining, preferably oxygen partial pressure in the oxygen-controlled refining is controlled to not more than 0.001 Pa, preferably element reaction and diffusion process are accelerated with the help of the electromagnetic stirring or the gas blowing stirring in the oxygen-controlled refining, preferably refining time is 10-30 min, and a refining temperature is 800-1100° C. in the oxygen-controlled refining.

Further, the oxygen-controlled refining comprises the following steps: adding a metallic copper, a copper alloy, a metallic zinc, a zinc alloy or a magnesium alloy to the aluminum alloy melt to perform removal and alloying treatment of elements in the aluminum alloy melt, preferably oxygen partial pressure in the oxygen-controlled refining is controlled to not more than 0.001 Pa.

A technical solution of the present disclosure is applied, cutting fluid and oil-water used in a processing process may be easily removed through performing the pre-treating, comprising the fire-roasting or wet-washing, on the processed aluminum scraps of aeronautical aluminum alloy, pollution of the processed aluminum scraps is reduced as much as possible, and an inclusion is avoided from being generated in a finally formed aluminum alloy product; heat transfer efficiency between the processed aluminum scraps may be increased through performing the pressing formation on the pre-treated processed aluminum scraps of aeronautical aluminum alloy, oxidation burning loss of the processed aluminum scraps is avoided, and a recovery rate of the processed aluminum scraps is greatly improved; and oxidation of aluminum scraps may be avoided through performing the oxygen-controlled smelting on the block-shaped aluminum scraps, the recovery rate of the processed aluminum scraps is greatly improved, and associated solid wastes, such as a molten slag and a molten salt and the like, are avoided from being generated. Therefore, through the method of the present disclosure, the aluminum alloy product of meeting the component requirements of aeronautical aluminum alloy may be prepared in a higher aluminum scrap recovery rate, the inclusion is avoided from being generated in the finally formed aluminum alloy product, the processed aluminum scraps of aeronautical aluminum alloy are efficiently recovered, and value-preservation and utilization of the processed aluminum scraps of aeronautical aluminum alloy are achieved.

It is to be noted that embodiments in the present application and features in the embodiments may be mutually combined in the case without conflicting. The present disclosure is described in detail below in combination with the embodiments.

As described in the background, recovery efficiency of processed aluminum scraps of aeronautical aluminum alloy in the prior art is low. In order to solve this problem, the present application provides a method for recovering processed aluminum scraps of aeronautical aluminum alloy, the method comprises the following steps: performing pre-treating, comprising fire-roasting or wet-washing, on the processed aluminum scraps of aeronautical aluminum alloy; performing pressing formation on the pre-treated processed aluminum scraps of aeronautical aluminum alloy to form block-shaped aluminum scraps; performing oxygen-controlled smelting on the block-shaped aluminum scraps in a smelting furnace to form aluminum alloy melt; and performing casting on the aluminum alloy melt to obtain an aluminum alloy product of meeting component requirements of aeronautical aluminum alloy.

In the present application, meeting the component requirements of aeronautical aluminum alloy refers to meeting component requirements of a specific aeronautical aluminum alloy, such as 2-series aluminum alloy such as a 2024-Al alloy or 7-series aluminum alloy such as a 7075-Al alloy and the like, specified in “GB/T3190-2008 wrought aluminum and aluminum alloy chemical components.”

The present application is capable of, through performing pre-treating, including fire-roasting or wet-washing, on the processed aluminum scraps of aeronautical aluminum alloy, easily removing cutting fluid and oil-water used in a processing process, reducing pollution of the processed aluminum scraps as much as possible, and avoiding an inclusion from being generated in a finally formed aluminum alloy product; heat transfer efficiency between the processed aluminum scraps may be increased through performing the pressing formation on the pre-treated processed aluminum scraps of aeronautical aluminum alloy, oxidation burning loss of the processed aluminum scraps is avoided, and a recovery rate of the processed aluminum scraps is greatly improved; and oxidation of aluminum scraps may be avoided through performing the oxygen-controlled smelting on the block-shaped aluminum scraps, the recovery rate of the processed aluminum scraps is greatly improved, and associated solid wastes, such as a molten slag and a molten salt and the like, are avoided from being generated. Therefore, through the method of the present disclosure, the aluminum alloy product of meeting the component requirements of aeronautical aluminum alloy may be prepared in a higher aluminum scrap recovery rate, the inclusion is avoided from being generated in the finally formed aluminum alloy product, the processed aluminum scraps of aeronautical aluminum alloy are efficiently recovered, and value-preservation and utilization of the processed aluminum scraps of aeronautical aluminum alloy are achieved.

The method of the present application further comprises performing oxygen-controlled refining on aluminum alloy melt to achieve component optimization of the aluminum alloy melt after oxygen-controlled smelting and before casting. Through such a mode, oxidation of an aluminum alloy may be avoided, volatile elements or gases are removed and the content of main elements, such as zinc, magnesium and copper and the like, in the processed aluminum scraps of aeronautical aluminum alloy is more accurately regulated and controlled.

In one preferable embodiment of the present application, the method for recovering the processed aluminum scraps of aeronautical aluminum alloy comprises the following steps: performing pre-treating, comprising fire-roasting or wet-washing and the like, on the processed aluminum scraps such as cutting aluminum scraps of aeronautical aluminum alloy; performing pressing formation on the pre-treated aluminum scraps at a certain forming pressure to form block-shaped aluminum scraps; and rapidly melting the pre-treated block-shaped aluminum scraps and achieving component optimization in a smelting furnace by using an oxygen-controlled smelting and refining process, to obtain an aluminum alloy product of meeting component requirements of aeronautical aluminum alloy finally.

In another example, the method for recovering processed aluminum scraps of aeronautical aluminum alloy, the method includes pre-treating the processed aluminum scraps of aeronautical aluminum alloy, the pre-treating comprising one or more of fire-roasting and wet-washing. The method further includes pressing the pre-treated processed aluminum scraps of aeronautical aluminum alloy to form block-shaped aluminum scraps. The method further includes oxygen-controlled smelting the block-shaped aluminum scraps in a smelting furnace to form aluminum alloy melt. The method further includes casting the aluminum alloy melt to obtain an aluminum alloy product.

In the present application, the oxygen-controlled smelting and refining process preformed in the smelting furnace may include two links of oxygen-controlled smelting and oxygen-controlled refining, in the oxygen-controlled smelting and refining process, vacuum or inert gas protection may be used to perform the control of oxygen potential, and according to raw material characteristics and product requirements, separate operation of the oxygen-controlled smelting is used or joint operation of the oxygen-controlled smelting and the oxygen-controlled refining is used.

The oxygen-controlled smelting and refining process of the processed aluminum scraps may be coordinated with a stirring mode. In the method for recovering the processed aluminum scraps of aeronautical aluminum alloy according to the present disclosure, during the oxygen-controlled smelting and refining process, the stirring mode, such as gas blowing stirring, electromagnetic stirring or mechanical stirring such as physical mechanical stirring and the like, may be used to accelerate a melting rate of the aluminum scraps and element reaction and diffusion processes.

The processed aluminum scraps of aeronautical aluminum alloy used in the present application may be one of processed aluminum scraps of 2-series aeronautical aluminum alloy and processed aluminum scraps of 7-series aeronautical aluminum alloy or mixtures of more of them. For example, a size of the processed aluminum scraps may be: Length×Width×Thickness=(2−10 mm)×(2−10 mm)×(0.5−2 mm).

A roasting furnace used in the fire-roasting may be a device such as a muffle furnace, a resistance furnace or an intermediate frequency furnace and the like. Preferably, the fire-roasting is performed in air atmosphere, thereby ensuring the presence of oxygen to oxidize organics. Oxygen concentration in air atmosphere is generally about 21 vol %. A roasting temperature in the fire-roasting is 100-500° C., so removal of the organics may be achieved and oxidation of the aluminum scraps is prevented. Preferably roasting time may be 10-30 min.

The wet-washing may comprise washing and drying. Washing liquid used in a washing process may be one of industrial water, high purity water or ethyl alcohol or mixtures of more of them. The washing process may be enhanced by using one or more of microwave vibration, ultrasonic vibration or the mechanical stirring in the washing process, washing efficiency is improved, and washing time is shortened.

Further, drying treatment is performed on the processed aluminum scraps after washing. A drying device used in a drying process is a conventional drying device such as a tunnel drying oven or an air dry oven and the like. A drying temperature used in the drying process may be 60-150° C., it is ensured that water is rapidly removed, and the oxidation of the aluminum scraps is prevented. Drying time may be 10-30 min.

A pressing machine used when the pressing formation is performed on the processed aluminum scraps of aeronautical aluminum alloy may be a conventional device such as a single-column hydraulic press, a four-column hydraulic press, a six-column hydraulic press, a grinding wheel forming hydraulic press, a Y28-type universal hydraulic press, a head forming hydraulic press or a Y32-100T hydraulic press and the like. A forming pressure used in a pressing formation process may be within a range of 20-700 MPa, preferably within a range of 30-600 MPa. A size specification of the block-shaped aluminum scraps (namely, an aluminum block) formed after the pressing formation may be determined according to a specification of the smelting furnace, preferably, a diameter of the block-shaped aluminum scraps formed after the pressing formation is 5-10 cm, and a thickness is 2-5 cm. A density of the block-shaped aluminum scraps formed after the pressing formation may be 1.0-5.0 t/m3, preferably 1.5-3.5 t/m3, and more preferably 2.0 t/m3-3.0 t/m3. Through enabling the density of the block-shaped aluminum scraps formed after the pressing formation to be controlled within the above range, heat transfer efficiency between the aluminum scraps may be increased, the oxidation burning loss of the aluminum scraps is avoided, and the recovery rate of the aluminum scraps is greatly improved.

A smelting furnace used in the method for recovering the processed aluminum scraps of aeronautical aluminum alloy of the present disclosure is an aluminum smelting device such as a vacuum resistance furnace, a vacuum induction furnace or the intermediate frequency furnace and the like. Vacuum or inert gas such as Ar and the like for protection may be used to perform the control of oxygen potential in the oxygen-controlled smelting process. Preferably, the inert gas is selected for protection in the oxygen-controlled smelting process, and oxidation of molten aluminum is prevented. Preferably, oxygen partial pressure in the oxygen-controlled smelting is controlled to not more than 0.001 Pa. The oxygen-controlled smelting may include achieving rapid melting of the block-shaped aluminum scraps in an oxygen-controlled condition. The melting of the block-shaped aluminum scraps may be accelerated with the help of the electromagnetic stirring or the gas blowing stirring in the oxygen-controlled smelting. Smelting time may be 10-30 min, and a smelting temperature may be 800-1100° C. in the oxygen-controlled smelting. Through controlling the smelting time and the smelting temperature in the oxygen-controlled smelting within the above range, the rapid melting of the block-shaped aluminum scraps may be ensured and long-time high-temperature burning loss of the molten aluminum is avoided.

Vacuum or inert gas such as Ar and the like for protection may be used to perform the control of oxygen potential in the oxygen-controlled refining process. Preferably, the vacuum is selected in the oxygen-controlled refining process, volatile impurity elements or gases may be removed. Preferably, oxygen partial pressure in the oxygen-controlled refining is controlled to not more than 0.001 Pa. The element reaction and diffusion processes may be accelerated with the help of the electromagnetic stirring or the gas blowing stirring in the oxygen-controlled refining process. Refining time may be 10-30 min, and a refining temperature may be 800-1100° C. in the oxygen-controlled refining. Through controlling the refining time and the refining temperature in the oxygen-controlled refining within the above range, the oxidation burning loss of the aluminum alloy may be avoided and the component optimization of the aluminum alloy melt is achieved.

After the processed aluminum scraps are completely melted, sampling analysis is performed on the aluminum alloy melt, and the oxygen-controlled refining is performed on the aluminum alloy melt according to detection results to achieve the component optimization of the aluminum alloy melt. Preferably, the oxygen-controlled refining may comprise the following steps: adding a metallic copper, a copper alloy, a metallic zinc, a zinc alloy or a magnesium alloy to the aluminum alloy melt to perform removal and alloying treatment of elements in the aluminum alloy melt. Preferably, oxygen partial pressure in the oxygen-controlled refining may be controlled to not more than 0.001 Pa. Impurities such as iron, silicon, gases and inclusions and the like may further be removed in the oxygen-controlled refining. Preferably, the removal of impurities may be performed by using an impurity removing mode such as centrifuging or filtering and the like.

In a process of the oxygen-controlled refining, an addition amount of metal or alloys such as a metallic copper, a copper alloy, a metallic zinc, a zinc alloy or a magnesium alloy and the like is determined by a difference between the actually detected components of the aluminum alloy melt and the target aluminum alloy components. It is assumed that detected content of a certain component in the aluminum alloy melt is X wt %, and the average content of the component in the target aluminum alloy is required to be Y wt %, if X wt % is less than Y wt %, a weight of the metal or alloys of the to-be-added component may be calculated according to the difference value between Y wt % and X wt %; if X wt % is greater than Y wt %, suitable removal of the component may be achieved by controlling the refining conditions.

According to the method for recovering the processed aluminum scraps of aeronautical aluminum alloy of the present disclosure, after the component optimization is performed on the aluminum alloy melt, the aluminum alloy melt is poured into an aluminum tank and cast into an aluminum ingot.

Compared with the prior art, the improvement of the present disclosure is shown in the following several aspects.

Through performing the pre-treating, comprising the fire-roasting or the wet-washing and the like, on the processed aluminum scraps of aeronautical aluminum alloy, the cutting fluid and oil-water used in the processing process may be easily removed, the pollution of the processed aluminum scraps is reduced as much as possible, and the inclusion is avoided from being generated in the finally formed aluminum alloy product.

A specific surface of the aluminum scraps is larger, and a distance between the aluminum scraps in a loose state is larger relatively, so that the heat transfer efficiency between particles is low in a heating process. In addition, because a mass of the aluminum scraps is light, the aluminum scraps may be floated on the surface of a molten pool, so that the oxidation burning loss thereof is serious. It is discovered from an experiment that a yield of the aluminum scraps is almost zero while the aluminum scraps are melted in the loose state and in the air. The present disclosure, based on the consideration of this phenomenon, provides performing the pressing formation treatment on the processed aluminum scraps of aeronautical aluminum alloy, through performing the pressing formation treatment on the processed aluminum scraps of aeronautical aluminum alloy, the heat transfer efficiency between the processed aluminum scraps may be increased, the oxidation burning loss of the processed aluminum scraps is avoided, and the recovery rate of the processed aluminum scraps is greatly improved.

The mass of the aluminum scraps is approximate to a mass of a flux, the aluminum scraps and the flux are easily mixed and difficult to separate, a trouble is brought to separation treatment after smelting. It is discovered from the experiment that the recovery rate of the aluminum scraps may be improved by the flux such as KCl and NaCl and the like, but a mixing degree of the flux and the aluminum ingot is larger, it is difficult to separate efficiently. In addition, a conventional flux oxygen-controlled mode mostly uses a special stirring mode to perform directional separation treatment on the flux, so a higher requirement is required on the device. The present disclosure provides performing the oxygen-controlled smelting on the block-shaped aluminum scraps, especially the smelting is performed with the help of modes such as the electromagnetic stirring or the gas blowing stirring and the like in a vacuum or inert atmosphere protection condition, the oxidation of the aluminum scraps may be avoided, the recovery rate of the processed aluminum scraps is greatly improved, and associated solid wastes such as a molten slag and a molten salt and the like, are avoided from being generated.

Aluminum has a strong binding capacity with oxygen, and an oxidation reaction is easy to happen. It is discovered from the experiment that after the aluminum scraps are melted, even in the atmosphere protection condition, a large amount of smoke may still occur while the temperature continues to be risen to a certain temperature, it is indicated that the oxidation happens to the molten aluminum, finally the yield is lower. Based on this experimental phenomenon, by selectively controlling parameters such as the heating temperature and the smelting time and so on in the smelting process, the smoke is avoided from being generated in the melting process of the aluminum scraps, thereby the yield of the aluminum scraps is greatly improved.

Through using the method for recovering the processed aluminum scraps of aeronautical aluminum alloy of the present disclosure, the rapid melting of the block-shaped aluminum scraps can be achieved and the aluminum alloy with the high yield and qualified components is obtained. Through the present disclosure, problems in a conventional aluminum scrap recovering process, such as cutting fluid and oil-water contamination, easy oxidation, a low recovery rate, and a large amount of burning loss of the aluminum during the melting process, may be solved well. The present disclosure has the low requirements to aluminum scrap specifications and forming conditions, and the associated solid wastes such as the molten slag and the molten salt and the like are avoided from being generated, so a green production requirement is achieved. In addition, it has great tolerance for types of cutting fluid and oil-water pollution sources, the size of the aluminum scraps and a range of the content.

The present disclosure is described in detail below in combination with specific examples and comparative examples. However, the following examples are only used to explain the present disclosure, the scope of protection of the present disclosure should include all content of claims, and is not limited to the present examples. Furthermore, through the following examples, all content described in the claims of the present disclosure may be completely realized by those skilled in the art.

### Example 1

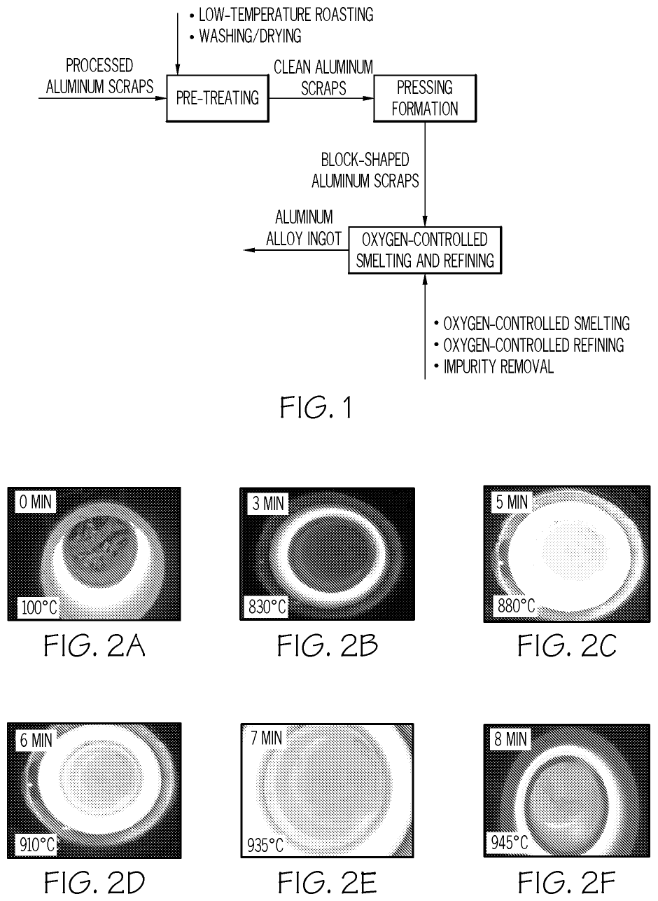

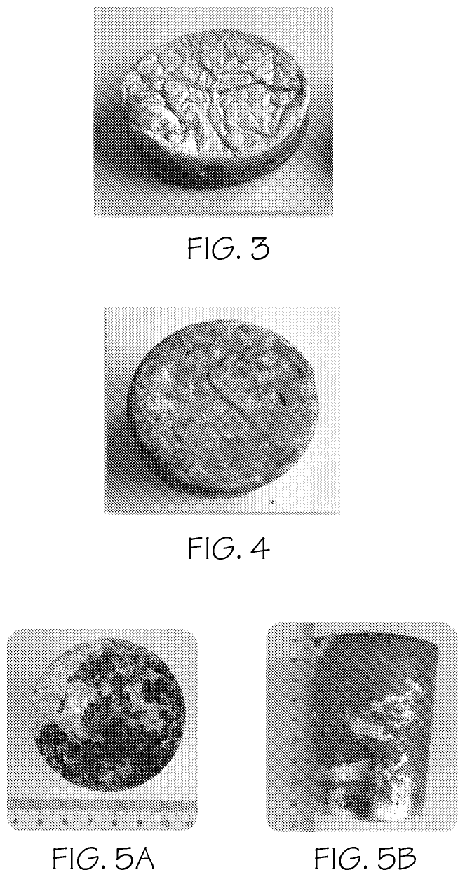

Cutting aluminum scraps of aeronautical aluminum alloy are aluminum scraps generated by cutting a 2024-Al aluminum ingot (aluminum scrap length: >2 mm, average width: 4 mm, average thickness: 0.5-2 mm, and cutting fluid is Hocut 795-B), the aluminum scraps are placed in a muffle furnace, roasted at 380° C. for 30 min in an air atmosphere, and then the aluminum scraps are pressed by using 30 MPa of a forming pressure into block-shaped aluminum scraps with 10 cm of a diameter, 2 cm of a thickness and 1.5 t/m3 of a density. 43.8 g of the block-shaped aluminum scraps after pressing are weighed and placed in a graphite crucible, and then the graphite crucible is placed in a vacuum induction furnace for smelting, temperature and time of the smelting are 950° C. and 10 min respectively, a vacuum degree is 50 Pa, and the oxygen partial pressure is less than 0.0005 Pa. Molten aluminum after smelting is poured into a cast iron tank and cast into an aluminum ingot, a 2024-Al alloy is prepared. FIGS. 2A-2F show photographs of an aluminum scrap melting process according to Example 1 of the present disclosure. FIG. 3 shows a photograph of a cast aluminum ingot according to Example 1 of the present disclosure. Table 2 shows component requirements of the 2024-Al alloy in “GB/T3190-2008 wrought aluminum and aluminum alloy chemical components.”

### Example 2

Cutting aluminum scraps of aeronautical aluminum alloy are aluminum scraps generated by cutting a 2024-Al aluminum ingot (aluminum scrap length: >2 mm, average width: 4 mm, average thickness: 0.5-2 mm, and cutting fluid is Hocut 795-B), the aluminum scraps are washed for 30 min in an ultrasonic cleaning machine loaded with industrial water, the washed aluminum scraps are placed in a drying oven, and dried in 80° C. for 60 min. The dried aluminum scraps are pressed by using 50 MPa of a forming pressure into block-shaped aluminum scraps with 10 cm of a diameter, 2 cm of a thickness and 1.9 t/m3 of a density. 48 g of the block-shaped aluminum scraps after drying are weighed and placed in a graphite crucible, and then the graphite crucible is placed in a vacuum induction furnace for smelting, temperature and time of the smelting are 950° C. and 10 min respectively, a vacuum degree is 50 Pa, and the oxygen partial pressure is less than 0.0005 Pa. Molten aluminum after smelting is poured into a cast iron tank and cast into an aluminum ingot, a 2024-Al alloy is prepared. FIG. 4 shows a photograph of a cast aluminum ingot according to Example 2 of the present disclosure.

### Example 3

Cutting aluminum scraps of aeronautical aluminum alloy are an aluminum scrap mixture generated by cutting 2024-Al and 7075-Al aluminum ingots (aluminum scrap length: 5-10 mm, average width: 5-10 mm, average thickness: 0.5-1 mm, and cutting fluid is Hocut 795-B), and a weight ratio of two types of the aluminum scraps is 1:1. The aluminum scrap mixture is placed in a muffle furnace, and roasted at 380° C. for 30 min in an air atmosphere, and then the aluminum scraps are pressed by using 200 MPa of a forming pressure into block-shaped aluminum scraps with 10 cm of a diameter, 5 cm of a thickness and 2.62 t/m3 of a density. 300 g of the block-shaped aluminum scraps after pressing are weighed and placed in a graphite crucible, and then the graphite crucible is placed in a vacuum induction furnace for smelting, temperature and time of the smelting are 950° C. and 10 min respectively, a vacuum degree is 50 Pa, and the oxygen partial pressure is less than 0.0005 Pa. After that, sampling analysis is performed on molten aluminum, and according to detection results, 3.75 g of metallic copper and 7.5 g of magnalium are added to molten aluminum for alloying of copper and magnesium under a vacuum condition, and smelting is performed for 10 min under an electromagnetic stirring condition. The molten aluminum after smelting is poured into a cast iron tank and cast into an aluminum ingot, a 2024-Al alloy is prepared. FIGS. 5A and 5B show photographs of a cast aluminum ingot according to Example 3 of the present disclosure.

### Example 4

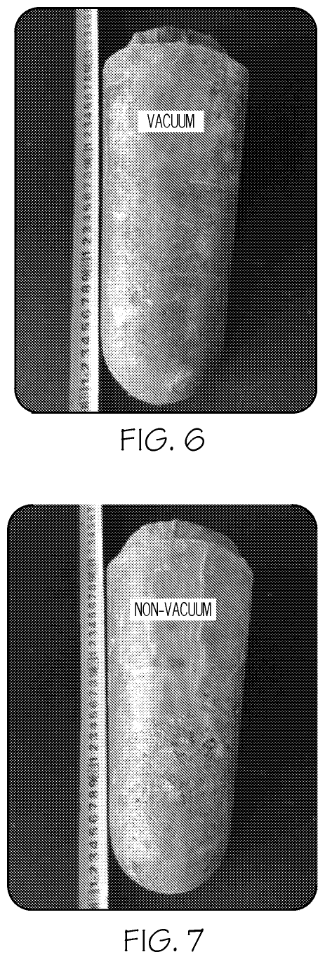

Cutting aluminum scraps of aeronautical aluminum alloy are an aluminum scrap mixture generated by cutting 2024-Al and 7075-Al aluminum ingots (aluminum scrap length: 5-10 mm, average width: 5-10 mm, average thickness: 0.5-1 mm, and cutting fluid is Hocut 795-B), and a weight ratio of two types of the aluminum scraps is 1:1. The aluminum scrap mixture is placed in a muffle furnace, and roasted at 380° C. for 30 min in an air atmosphere, and then the aluminum scraps are pressed by using 400 MPa of a forming pressure into block-shaped aluminum scraps with 10 cm of a diameter, 5 cm of a thickness and 3.15 t/m3 of a density. 12 kg of the block-shaped aluminum scraps after pressing are weighed and placed in a graphite crucible, and then the graphite crucible is placed in a vacuum induction furnace for smelting, temperature and time of the smelting are 950° C. and 10 min respectively, a vacuum degree is 50 Pa, and the oxygen partial pressure is less than 0.0005 Pa. After that, sampling analysis is performed on molten aluminum, and according to detection results, 0.15 kg of metallic copper and 0.3 kg of magnalium are added to molten aluminum for alloying of copper and magnesium under a vacuum condition, and smelting is performed for 10 min under an electromagnetic stirring condition. The molten aluminum after smelting is poured into a cast iron tank and cast into an aluminum ingot, a 2024-Al alloy is prepared. FIG. 6 shows a photograph of a cast aluminum ingot according to Example 4 of the present disclosure.

### Example 5

Cutting aluminum scraps of aeronautical aluminum alloy are an aluminum scrap mixture generated by cutting 2024-Al and 7075-Al aluminum ingots (aluminum scrap length: 5-10 mm, average width: 5-10 mm, average thickness: 0.5-1 mm, and cutting fluid is Hocut 795-B), and a weight ratio of two types of the aluminum scraps is 1:1. The aluminum scrap mixture is placed in a muffle furnace, and roasted at 380° C. for 30 min in an air atmosphere, and then the aluminum scraps are pressed by using 600 MPa of a forming pressure into block-shaped aluminum scraps with 10 cm of a diameter, 5 cm of a thickness and 4.0 t/m3 of a density. 15 kg of the block-shaped aluminum scraps after pressing are weighed and placed in a graphite crucible, and then the graphite crucible is placed in a vacuum induction furnace for smelting, temperature and time of the smelting are 950° C. and 10 min respectively, an Ar gas is used for protection, and the oxygen partial pressure is less than 0.0005 Pa. After that, sampling analysis is performed on molten aluminum, and according to detection results, 0.5 kg of metallic zinc and 0.65 kg of magnalium are added to molten aluminum for alloying of zinc and magnesium under an Ar gas protection condition, and smelting is performed for 10 min under an electromagnetic stirring condition. The molten aluminum after smelting is poured into a cast iron tank and cast into an aluminum ingot, a 7075-Al alloy is prepared. Table 2 shows component requirements of the 7075-Al alloy in “GB/T3190-2008 wrought aluminum and aluminum alloy chemical components.”

### Comparative Example 1

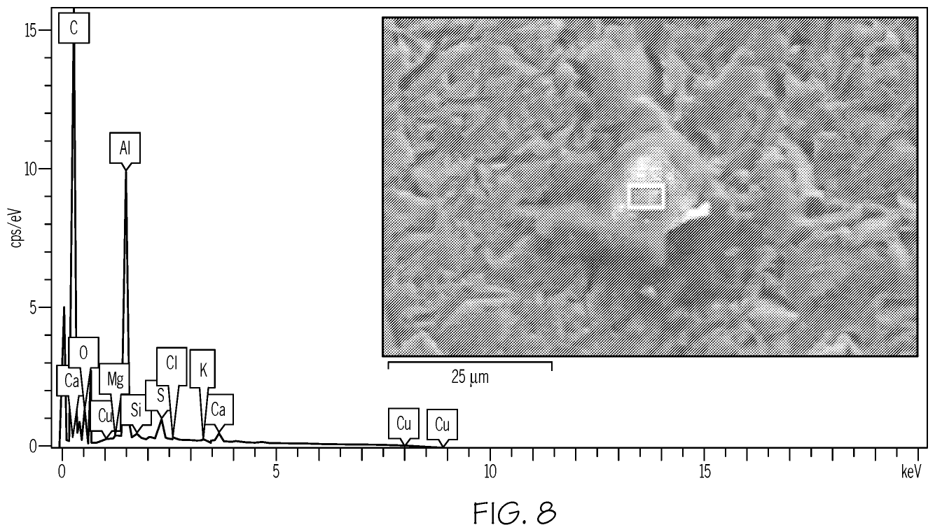

Cutting aluminum scraps of aeronautical aluminum alloy are an aluminum scrap mixture generated by cutting 2024-Al and 7075-Al aluminum ingots (aluminum scrap length: 5-10 mm, average width: 5-10 mm, average thickness: 0.5-1 mm, and cutting fluid is Hocut 795-B), and a weight ratio of two types of the aluminum scraps is 1:1. The aluminum scrap mixture is placed in a muffle furnace, and roasted at 380° C. for 30 min in an air atmosphere, and then the aluminum scraps are pressed by using 400 MPa of a forming pressure into block-shaped aluminum scraps with 10 cm of a diameter, 5 cm of a thickness and 3.15 t/m3 of a density. 12 kg of the block-shaped aluminum scraps after pressing are weighed and placed in a graphite crucible, and then the graphite crucible is placed in an induction furnace, and smelted in an air atmosphere, temperature and time of the smelting are 950° C. and 10 min respectively. After that, sampling analysis is performed on molten aluminum, and according to detection results, 0.15 kg of metallic copper and 0.3 kg of magnalium are added to molten aluminum for alloying of copper and magnesium in an air atmosphere, and smelting is performed for 10 min under an electromagnetic stirring condition. The molten aluminum after smelting is poured into a cast iron tank and cast into an aluminum ingot. FIG. 7 shows a photograph of a cast aluminum ingot according to Comparative example 1 of the present disclosure.

### Comparative Example 2

Cutting aluminum scraps of aeronautical aluminum alloy are an aluminum scrap mixture generated by cutting 2024-Al and 7075-Al aluminum ingots (aluminum scrap length: 5-10 mm, average width: 5-10 mm, average thickness: 0.5-1 mm, and cutting fluid is Hocut 795-B), and a weight ratio of two types of the aluminum scraps is 1:1. The aluminum scraps are pressed by using 400 MPa of a forming pressure into block-shaped aluminum scraps with 10 cm of a diameter, 5 cm of a thickness and 3.15 t/m3 of a density. 12 kg of the block-shaped aluminum scraps after pressing are weighed and placed in a graphite crucible, and then the graphite crucible is placed in a vacuum induction furnace for smelting, temperature and time of the smelting are 950° C. and 10 min respectively, a vacuum degree is 50 Pa, and the oxygen partial pressure is less than 0.0005 Pa. After that, sampling analysis is performed on molten aluminum, and according to detection results, 0.15 kg of metallic copper and 0.3 kg of magnalium are added to molten aluminum for alloying of copper and magnesium under a vacuum condition, and smelting is performed for 10 min under an electromagnetic stirring condition. The molten aluminum after smelting is poured into a cast iron tank and cast into an aluminum ingot.

### Comparative Example 3

Cutting aluminum scraps of aeronautical aluminum alloy are an aluminum scrap mixture generated by cutting 2024-Al and 7075-Al aluminum ingots (aluminum scrap length: 5-10 mm, average width: 5-10 mm, average thickness: 0.5-1 mm, and cutting fluid is Hocut 795-B), and a weight ratio of two types of the aluminum scraps is 1:1. The aluminum scrap mixture is placed in a muffle furnace, and roasted at 380° C. for 30 min in an air atmosphere. 3 kg of the aluminum scraps are weighed and placed in a graphite crucible, and then the graphite crucible is placed in a vacuum induction furnace for smelting, temperature and time of the smelting are 1100° C. and 20 min respectively, a vacuum degree is 50 Pa, and the oxygen partial pressure is less than 0.0005 Pa. After that, sampling analysis is performed on molten aluminum, and according to detection results, 0.15 kg of metallic copper and 0.3 kg of magnalium are added to molten aluminum for alloying of copper and magnesium under a vacuum condition, and smelting is performed for 10 min under an electromagnetic stirring condition. The molten aluminum after smelting is poured into a cast iron tank and cast into an aluminum ingot.

TABLE 1
Test results of examples and comparative examples

| | Aluminum scrap | Content of main elements in cast aluminum ingot (wt %) | | | | | | | | |
|---|---|---|---|---|---|---|---|---|---|---|
| | recovery rate (%) | Al | Cu | Mg | Si | Zn | Mn | Cr | Fe | C |
| Example 1 | 99.3 | 91.9 | 4.86 | 1.63 | 0.48 | 0.087 | 0.45 | 0.08 | 0.48 | 1.02 ppm |
| Example 2 | 99.4 | 92.9 | 4.24 | 1.44 | 0.46 | 0.034 | 0.43 | 0.074 | 0.42 | 1.05 ppm |
| Example 3 | 99.2 | 92.4 | 4.64 | 1.46 | 0.45 | 0.14 | 0.37 | 0.06 | 0.45 | 1.09 ppm |
| Example 4 | 99.1 | 93.4 | 4.14 | 1.21 | 0.39 | 0.089 | 0.39 | 0.02 | 0.3 | 1.07 ppm |
| Example 5 | 99.6 | 89.7 | 1.92 | 2.2 | 0.35 | 5.12 | 0.21 | 0.02 | 0.42 | 0.92 ppm |
| Comparative example 1 | 92.5 | 90.55 | 4.32 | 2.11 | 0.39 | 1.31 | 0.41 | 0.055 | 0.39 | 1.03 ppm |
| Comparative example 2 | 98.8 | 92.6 | 4.19 | 1.81 | 0.41 | 0.02 | 0.48 | 0.04 | 0.41 | 2.02 ppm |
| Comparative example 3 | 95.5 | 90.43 | 4.68 | 2.05 | 0.46 | 0.4 | 0.98 | 0.08 | 0.45 | 1.07 ppm |

TABLE 2
Requirements of “GB/T3190-2008 wrought aluminum and
aluminum alloy chemical components” (wt %)

| | Cu | Mg | Si | Zn | Mn | Cr | Fe |
|---|---|---|---|---|---|---|---|
| 2024- | 3.80-4.90 | 1.20-1.80 | <0.50 | <0.25 | 0.30-0.90 | <0.10 | <0.50 |
| Al | | | | | | | |
| 7075- | 1.20-2.0 | 2.10-2.90 | <0.60 | 5.1-6.1 | <0.3 | <0.10 | <0.50 |
| Al | | | | | | | |

Compared with Example 1, the pre-treating mode is changed in Example 2, namely the cutting fluid and oil-water are removed by using the modes of fire-roasting and wet-washing respectively in Example 1 and Example 2. In Example 3, on the basis of the 2-series aluminum scraps, 50% of the 7-series aluminum scraps are mixed and the 2-series aluminum alloy is prepared, Zn removing and Mg and Cu alloying processes are added. In Example 4, a scale-up experiment is performed on the basis of Example 3, and a scale is enlarged from 300 g to 12 kg. In Example 5, on the basis of Example 4, through using the Ar gas protection, and performing the alloying treatment of Zn and Mg, the 7075-Al alloy is prepared, and the alloy component requirements are satisfied. In Comparative example 1, a vacuum oxygen-controlled link is eliminated in allusion to Example 4, effects of the oxygen-controlled smelting and refining on the aluminum scrap melting and the component optimization are compared. In Comparative example 2, the pre-treating, including the fire-roasting or the wet-washing, is not performed, effects of the pre-treating on the aluminum scrap recovery are compared. In Comparative example 3, briquetting treatment is not performed on the aluminum scraps, effects of the briquetting treatment on the aluminum scrap recovery are compared.

It may be seen from Table 1 that under two modes in Example 1 and Example 2, the present disclosure is capable of achieving the rapid melting of the block-shaped aluminum scraps, the recovery rate of the aluminum scraps is up to 99% or more, and components of the aluminum ingot after smelting meet the requirements of the 2024-Al alloy, and requirements of the value-preservation and utilization of the aluminum scraps are achieved. In Example 3 and Example 4, 2-series and 7-series cutting aluminum scrap mixtures are used as an object, from 300 g of a small experiment to 12 kg of a scale-up experiment, 99% or more of the aluminum scrap recovery rates are achieved both, and the components of the aluminum ingot after smelting meet the requirements of the 2024-Al alloy, and the requirements of the value-preservation and utilization of the aluminum scraps are satisfied. In Comparative example 1, the smelting and refining is performed without using the oxygen-controlled condition, as a result, the recovery rate of the aluminum scraps is low and the main component zinc fails to be reduced to the range within the component requirements of the 2024-Al alloy, and the magnesium content is beyond the range of the component requirements of the 2024-Al alloy, it proves the necessity of the oxygen control. In Comparative example 2, the smelting and refining is performed under the condition without performing the fire-roasting or wet-washing, as a result, 2.02 ppm of the carbon content in the final aluminum alloy is apparently higher than about 1 ppm in other examples, and the carbide inclusion (reference to FIG. 8) is apparently discovered under the electron microscope. The aluminum alloy obtained in Example 1-5 is observed under the electron microscope, and any carbide inclusions are not discovered. These carbides may have the apparent effect on properties of the alloy, it proves the importance of performing the roasting pre-treating on the aluminum scraps. In Comparative example 3, the 2-series and 7-series cutting aluminum scrap mixtures are used as an object, the briquetting treatment is not used, the temperature and time in the smelting and refining process are apparently increased, and the recovery rate is reduced relatively, and some element components fails to meet the alloy requirements.

From the above description, it may be seen that the above examples of the present disclosure achieve the following technical effects.

The removal of the cutting fluid and oil-water on the surface layer of the aluminum scraps is achieved by the pre-treating of the fire-roasting or the wet-washing both, there is no apparent difference in the final aluminum scrap recovery, it proves that both pre-treating modes are feasible.

The density of the block-shaped aluminum craps formed after the pressing formation may be varied in a large span range from 1.0 t/m3 to 5.0 t/m3, the oxygen-controlled smelting and refining process may achieve the good melting and component optimization, thus it may prove that the present disclosure has a low requirement to the specifications of the aluminum scraps before charging the furnace.

The oxygen-controlled smelting and refining process is capable of greatly improving the recovery rate of the processed aluminum scraps, achieving high-value conversion of the aluminum scraps, and avoiding the associated solid wastes such as the molten slag and the molten salt and the like from being generated. Therefore, through the method of the present disclosure, the processed aluminum scraps may be more efficiently recovered.

The present application is capable of, through performing pre-treating, including the fire-roasting or wet-washing, on the processed aluminum scraps of aeronautical aluminum alloy, easily removing the cutting fluid and oil-water used in a processing process, reducing pollution of the processed aluminum scraps as much as possible, and avoiding an inclusion from being generated in a finally formed aluminum alloy product; heat transfer efficiency between the processed aluminum scraps may be increased through performing the pressing formation on the pre-treated processed aluminum scraps of aeronautical aluminum alloy, oxidation burning loss of the processed aluminum scraps is avoided, and a recovery rate of the processed aluminum scraps is greatly improved; and oxidation of aluminum scraps may be avoided through performing the oxygen-controlled smelting on the block-shaped aluminum scraps, the recovery rate of the processed aluminum scraps is greatly improved, and associated solid wastes, such as the molten slag and the molten salt and the like, are avoided from being generated. Therefore, through the method of the present disclosure, the aluminum alloy product of meeting the component requirements of aeronautical aluminum alloy may be prepared in a higher aluminum scrap recovery rate, the inclusion is avoided from being generated in the finally formed aluminum alloy product, the processed aluminum scraps of aeronautical aluminum alloy are efficiently recovered, and the value-preservation and utilization of the processed aluminum scraps of aeronautical aluminum alloy are achieved.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represent a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The above is only the preferable examples of the present disclosure, and is not intended to limit the present disclosure. Various modifications and changes may be made to the present disclosure by those skilled in the art. Any modifications, equivalent replacements, improvements and the like made within spirit and principle of the present disclosure should be included in the scope of protection of the present disclosure.

What is claimed is:

1. A method for recovering processed aluminum scraps of aeronautical aluminum alloy, the method comprising:
performing pre-treating, comprising fire-roasting or wet-washing, on the processed aluminum scraps of aeronautical aluminum alloy;
performing pressing formation on the processed aluminum scraps of aeronautical aluminum alloy to form block-shaped aluminum scraps;
performing oxygen-controlled smelting on the block-shaped aluminum scraps in a smelting furnace to form aluminum alloy melt; and
performing casting on the aluminum alloy melt to obtain an aluminum alloy product of meeting component requirements of aeronautical aluminum alloy.

2. The method of claim 1, further comprising performing oxygen-controlled refining the aluminum alloy melt after the oxygen-controlled smelting and before the casting.

3. The method of claim 1, wherein the processed aluminum scraps of aeronautical aluminum alloy comprise one or more of processed aluminum scraps of 2-series aluminum alloy and processed aluminum scraps of 7-series aluminum alloy.

4. The method of claim 1, wherein the fire-roasting is performed in air atmosphere, and a roasting temperature in the fire-roasting is 100-500° C.

5. The method of claim 1, wherein the wet-washing comprises washing and drying, washing liquid used in a washing process is one or more of industrial water, high purity water or ethyl alcohol, wherein the washing process is enhanced by using one or more of microwave vibration, ultrasonic vibration or mechanical stirring in the washing process, and

6. The method of claim 5, wherein a drying temperature used in a drying process is approximately 60° C. to approximately 150° C.

7. The method of claim 1, wherein a density of the block-shaped aluminum scraps formed after the pressing formation is 1.0-5.0 t/m3.

8. The method of claim 1, wherein in the oxygen-controlled smelting, vacuum or inert gas protection is used to control oxygen potential to an oxygen partial pressure in the oxygen-controlled smelting of not more than 0.001 Pa.

9. The method of claim 1, wherein the oxygen-controlled smelting comprises achieving rapid melting of the block-shaped aluminum scraps in an oxygen-controlled condition.

10. The method of claim 9, wherein the rapid melting of the block-shaped aluminum scraps is accelerated with electromagnetic stirring or gas blowing stirring in the oxygen-controlled smelting.

11. The method of claim 1, wherein smelting time is approximately 10 min to approximately 30 min.

12. The method of claim 1, wherein the smelting is performed at a smelting temperature of approximately 800° C. to approximately 1100° C. in an oxygen-controlled smelting condition.

13. The method of claim 2, wherein vacuum or inert gas protection is used to control oxygen potential in the oxygen-controlled refining.

14. The method of claim 13, wherein an oxygen partial pressure in the oxygen-controlled refining is controlled to not more than about 0.001 Pa.

15. The method of claim 2, wherein element reaction and diffusion process are accelerated with the help of electromagnetic stirring or gas blowing stirring in the oxygen-controlled refining.

16. The method of claim 2, comprising a refining time of approximately 10 min to approximately 30 min.

17. The method of claim 2, wherein the refining is performed at a refining temperature of about 800° C. to about 1100° C. in an oxygen-controlled refining condition.

18. The method of claim 2, wherein the oxygen-controlled refining comprises adding one or more of a metallic copper, a copper alloy, a metallic zinc, a zinc alloy and a magnesium alloy to the aluminum alloy melt to perform removal and alloying treatment of elements in the aluminum alloy melt,

19. The method of claim 2, wherein an oxygen partial pressure in the oxygen-controlled refining is up to 0.001 Pa.

20. A method for recovering processed aluminum scraps of aeronautical aluminum alloy, the method comprising:
pre-treating the processed aluminum scraps of aeronautical aluminum alloy, the pre-treating comprising one or more of fire-roasting and wet-washing;
pressing the pre-treated processed aluminum scraps of aeronautical aluminum alloy to form block-shaped aluminum scraps;
oxygen-controlled smelting the block-shaped aluminum scraps in a smelting furnace to form aluminum alloy melt; and
casting the aluminum alloy melt to obtain an aluminum alloy product.
